(19) United States
(12) Patent Application Publication
(10) Pub. No.: US 2011/0282027 A1
(43) Pub. Date: Nov. 17, 2011

(54) PROCESS FOR PRODUCING POLYETHEROLS

(75) Inventors: Peter DEGLMANN, Mannheim (DE); Sirus Zarbakhsh, Central Hong Kong (CN); Achim Löffler, Speyer (DE); Kerstin Wiss, Mannheim (DE)

(73) Assignee: BASF SE, Ludwigshafen (DE)

(21) Appl. No.: 13/103,383

(22) Filed: May 9, 2011

Related U.S. Application Data
(60) Provisional application No. 61/334,602, filed on May 14, 2010.

(51) Int. Cl. C08G 65/28

(52) U.S. Cl. 528/405

(57) ABSTRACT

The present invention relates to processes for producing polyetherols, in particular to polyetherol block structures, to novel catalysts for use in said processes, and to the polyetherols that can be produced via the process of the invention. The present invention further relates to the use, for producing polyurethanes, of the polyetherols that can be produced in the invention.

The present invention relates to processes for producing polyetherols, in particular to polyetherol block structures, to novel catalysts for use in said processes, and to the polyetherols that can be produced via the process of the invention. The present invention further relates to the use, for producing polyurethanes, of the polyetherols that can be produced in the invention.

### BACKGROUND

For the purposes of the present disclosure, the terms “polyether alcohol” and “polyetherol” are used synonymously.

It has long been known that polyether alcohols can be produced via anionic ring-opening polymerization of alkylene oxides.

Further details in this respect can by way of example be found in Kunststoffhandbuch, Band VII, Polyurethane [Plastics handbook, volume VII, Polyurethanes], Carl-Hanser-Verlag, Munich, 1st edition 1966, edited by Dr. R. Vieweg and Dr. A. Höchtlen, and 2nd edition 1983 and 3rd edition 1993, edited by Dr. G. Oertel, or M. Szycher, Szycher's Handbook of Polyurethanes, CRC Press, New York 1999, chapter 5 “Polyols”.

The addition reaction using the alkylene oxides usually uses catalysts. The catalysts used for this purpose in industry are mainly basic catalysts, and in particular alkaline catalysts.

Basic compounds such as alkali metal hydroxides and alkaline earth metal hydroxides are regarded as the standard catalysts for producing polyether alcohols; potassium hydroxide (KOH) is the most widely used.

Production of polyether alcohols is also described in M. Ionescu, “Chemistry and Technology of Polyols for Polyurethanes”, Rapra Technology, 2005.

Compounds often used as alkylene oxide starting materials for producing polyether alcohols are propylene oxide (PO) and/or ethylene oxide (EO).

Polyether alcohols (polyetherols) are starting materials often used for producing polyurethanes (PUs). The nature of the polyetherol used here has a major effect on the properties of the polyurethane product, and it is therefore very important to produce polyetherols with defined properties, as a function of the desired polyurethane. It is therefore often necessary to produce polyetherols having block structures, an example being polyetherols having a core made of PO and having a cap made of EO.

In many applications, e.g. in the production of polyurethanes, a high proportion of EO in the cap is desirable, since when EO is used as starting material in the production of polyetherols it delivers primary OH groups within the polyetherol, and this increases the reactivity of the polyetherol during urethanization.

As mentioned, the formation of adducts from the cyclic alkylene oxides, for example onto compounds comprising OH groups, usually uses catalysts.

The book by lonescu gives a detailed discussion of organocatalysts for the ring-opening polymerization of alkylene oxides (M. lonescu, Chemistry and Technology of Polyols for Polyurethanes, Rapra Technology, 2005). These are exclusively N-nucleophils, which give acceptable conversions in the homopolymerization of EO, but in the case of propylene oxide (PO) and of other substituted monomers can only produce low-molecular-weight oligomers (<5 PO per OH group of the starter). Nor, therefore, do these amine catalysts permit production of block copolymers composed of a core of substituted alkylene oxides (e.g. propylene oxide or butylene oxide) and of a cap made of EO.

Nor can this capping of, e.g. polypropylene oxide (PPO) blocks with a small proportion of EO, i.e. the attachment of a polyethylene oxide block to a polypropylene oxide block, be achieved in any well-defined manner by using other established alkoxylation catalysts, for example DMC (double-metal cyanide). When KOH is used as catalyst this is possible, but complicated subsequent work-up of the product is then required.

N-Heterocyclic carbenes (NHC) are another class of catalysts that for some years have been known as initiators or organocatalysts for the ring-opening polymerization reaction (Dove et al., Polymer 47 (2006), 4018). The stoichiometric ring opening of ethylene oxide (EO) in solution has also recently been described by Raynaud et al. (JACS, 131 (2009), 3201), and long reaction times here produce zwitterionic PEG (polyethylene glycol) oligomers. When the reaction mixture is quenched with water, these are converted to diols; as an alternative, it is also possible to establish other terminal functionalities by transfer of the PEG chains onto nucleophils (examples being benzyl esters on quenching with benzyl alcohol, and azides on quenching with trimethylsilyl azide). The same procedure is also described by the same authors in the patent application WO 2009/013344, where the monomers claimed comprise all of the industrially relevant alkylene oxides, and the catalysts claimed comprise all of the familiar carbene structures. However, specific examples are given only for EO. However, the catalytic ring-opening polymerization reaction of ethylene oxide had been described as much as three years previously by Mason et al. (Polym. Prepr., Am. Chem. Soc., Div. Polym. Chem., 2006, 47, 99-100).

It was therefore an object to provide a process which can produce polyetherols and which in particular is suitable for producing block structures, and which maximizes the possibility of EO capping.

The process should moreover minimize the number of side reactions and have maximum ease of operation, and also minimum process time. The products of the process, i.e. the polyetherols, should have good suitability for producing polyurethanes (PUs).

### DESCRIPTION OF THE INVENTION

Surprisingly, it has now been found that the abovementioned object could be achieved via catalytic ring-opening polymerization of alkylene oxides with use of at least one N-heterocyclic carbene as catalyst.

The present invention therefore provides a process for producing polyetherols via catalytic ring-opening polymerization of alkylene oxides with at least one at least monofunctional compound which is reactive toward alkylene oxides, where at least one N-heterocyclic carbene is used as catalyst.

The present invention further provides the novel carbene catalyst, and also the use thereof in a process for producing polyetherols, the polyetherols that can be produced by the process of the invention, and the use of these for producing polyurethanes.

The use in the invention of an N-heterocyclic carbene as catalyst for the catalytic ring-opening polymerization of alkylene oxides permits inter alia production of high-molecular-weight block-copolymer polyetherols, for example having EO endcaps. The polyetherols thus produced have high reactivity, due to the primary OH groups, and they therefore have excellent suitability for further reaction to give polyurethanes, for example for use as molded flexible foams.

The process of the invention for producing polyetherols with use of an N-heterocyclic carbene as catalyst for the catalytic ring-opening polymerization of alkylene oxides is particularly suitable when the starting materials used comprise substituted alkylene oxides, an example being propylene oxide or butylene oxide. When the process of the invention is used, the extent of side reactions occurring with these starting materials, for example formation of unsaturated byproducts, such as allyl alcohols, is markedly reduced in comparison with conventional processes, such as those used in KOH catalysis.

Another advantage of the process of the invention is that it does not require the work-up steps of neutralization and filtration which are necessary in the KOH-catalyzed production of polyetherols.

When the process of the invention is used, the catalyst concentrations needed are moreover generally lower than for the conventional KOH-catalyzed process, and the reaction temperatures are generally lower. This means that the activity of the catalyst of the invention is markedly higher than that of the conventional catalysts, such as KOH catalysts or amine catalysts.

When the process of the invention is used, the viscosity of the reaction mixture is generally lower than in the conventional KOH-catalyzed process, and this permits better dissipation of the heat of reaction.

Finally, when the polyetherols produced in the invention are further processed to give polyurethanes, the reactivity (hardening time) of the resultant polyurethane can be adjusted within wide limits. The reason for this is that the NHC catalyst of the invention can also be used as catalyst for polyurethane production; if the NHC catalyst of the invention is not quenched at the end of the process of the invention and thus remains within the polyetherol product, the reactivity of the polyol can thus be increased in a process for production of PU (or the amount of regular PU catalyst can be reduced). The term “quenching” here means the deactivation of the catalyst via chemical reaction, e.g. via hydrolysis or oxidation.

The process of the invention for producing polyetherols with use of an N-heterocyclic carbene as catalyst for the catalytic ring-opening polymerization of alkylene oxides therefore provides numerous advantages over the established processes.

A novel class of high-activity catalyst has thus been found for the ring-opening polymerization of alkylene oxides. The catalyst of the invention can also be used for copolymerization, for example with lactones, with lactide, and/or with cyclic siloxanes.

Examples of suitable lactones for copolymerization with alkylene oxides are substituted or unsubstituted lactones having 4-membered or larger rings, examples being β-propiolactone, δ-valerolactone, ε-caprolactone, methyl-ε-caprolactone, β,β-dimethyl-β-propiolactone, β-methyl-β-propiolactone, α-methyl-β-propiolactone, α,α-bis(chloromethyl)propiolactone, methoxy-ε-caprolactone, ethoxy-ε-caprolactone, cyclohexyl-ε-caprolactone, phenyl-ε-caprolactone, benzyl-ε-caprolactone, ζ-enantholactone, η-caprylolactone, α,β,γ-trimethoxy-δ-valerolactone, or β-butyrolactones, and mixtures thereof. One embodiment uses ε-caprolactone.

Because the activity of the catalyst is high, it is possible to achieve high degrees of alkoxylation, and this also applies in particular when using substituted alkylene oxides, such as propylene oxide.

The polyetherol products can by way of example be used as a constituent of the A component of PU systems for flexible-foam applications (flexible foam slabs, molded flexible foam), for rigid-foam applications, and for elastomers, coatings, and adhesives, and in the form of carrier oils, and also in the form of surfactant substances for cosmetics chemicals and surfactant substances for household chemicals, and also for construction chemistry.

It has been possible to show that the reaction of EO and PO using catalytic amounts of NHC in the presence of a starter containing OH groups leads to polyalkylene oxide with narrow mass distribution, as can be seen from polydispersity data (see example 2).

Surprisingly, it has also been found that, unlike other organocatalysts, NHCs can provide a reaction which is equally catalytic and stoichiometric for conversion of mono- and disubstituted alkylene oxides, in particular propylene oxide and butylene oxide, to give not merely oligomers but also the corresponding polyetherols (with high M_{w}, for example up to 12 000 g/mol).

By using NHC catalysts it is therefore also possible for the first time to obtain random and also block copolymers from the abovementioned monomers, in particular EO-capped PPG cores.

It is preferable to use a catalyst of the invention.

The catalyst of the invention is preferably selected from the group comprising

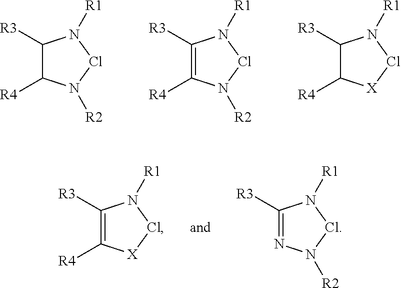

where X has been selected from the group comprising O and S; R1 has been selected from the group comprising alkyl, aryl; R2, if present, has been selected from the group comprising alkyl, aryl; each of R3 and R4 has been selected from the group comprising H, alkyl, aryl.

Ring closures between R1 and R3, R3 and R4, and also R4 and R2, are likewise possible.

The alkyl groups here are preferably in each case selected from the group comprising methyl, ethyl, propyl, butyl, pentyl, hexyl, heptyl, octyl, particularly preferably methyl, ethyl, isopropyl, tert-butyl.

The aryl groups are preferably in each case selected from the group comprising phenyl and mesityl.

If the radical R2 is not present, R1 is preferably a secondary or tertiary alkyl or mesityl group, particularly preferably a tertiary alkyl group.

If both groups R1 and R2 are present, it is preferable that at least one of the two radicals R1 and R2 is a primary alkyl group, e.g. methyl, ethyl, n-propyl or n-butyl.

It is equally preferable that if both groups R1 and R2 are present, at least one of the two radicals R1 and R2 is a secondary alkyl group, e.g. isopropyl.

In one preferred embodiment of the invention, in which both groups R1 and R2 are present, both radicals R1 and R2 are secondary alkyl groups.

In another preferred embodiment of the invention, in which both groups R1 and R2 are present, one of the two radicals R1 and R2 is a primary alkyl group and the other of the two radicals is a secondary alkyl group.

In one embodiment of the invention, in which both groups R1 and R2 are present, it is particularly preferable that both radicals R1 and R2 are primary alkyl groups.

Preference is also given to the following structures:

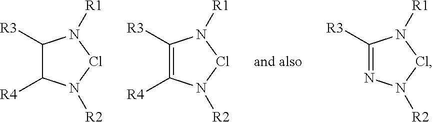

where the general and preferred definitions of R1, R2, R3, and R4 are as above.

One preferred embodiment uses the following catalyst:

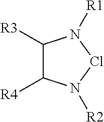

where the general and preferred definitions of R1, R2, R3, and R4 are as above. It is therefore preferable that at least one of the two radicals R1 and R2 is a primary alkyl group; it is equally preferable that at least one of the two radicals R1 and R2 is a secondary alkyl group. It is particularly preferable that both radicals R1 and R2 are primary alkyl groups.

Another preferred embodiment of the invention uses the following catalyst:

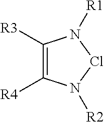

where the general and preferred definitions of R1, R2, R3, and R4 are as above. It is therefore preferable that at least one of the two radicals R1 and R2 is a primary alkyl group; it is equally preferable that at least one of the two radicals R1 and R2 is a secondary alkyl group. It is particularly preferable that both radicals R1 and R2 are primary alkyl groups.

Another preferred embodiment of the invention uses the following catalyst:

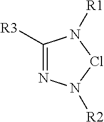

where the general and preferred definitions of R1, R2, R3, and R4 are as above.

It is therefore preferable that at least one of the two radicals R1 and R2 is a primary alkyl group; it is equally preferable that at least one of the two radicals R1 and R2 is a secondary alkyl group. It is particularly preferable that both radicals R1 and R2 are primary alkyl groups.

The amount usually used of the catalyst of the invention is from 0.001 to 1.5% by weight, preferably from 0.01 to 1.0% by weight, particularly preferably from 0.1 to 0.7% by weight, based on the amount of starter plus alkylene oxide(s).

It is also possible to use a mixture of various catalysts of the invention, or a mixture of catalysts of the invention with conventional catalysts.

For the purposes of the present invention, the at least monofunctional compound which is reactive toward alkylene oxides is also termed a starter.

It is preferable to use an at least monofunctional compound which is reactive toward alkylene oxides.

In one embodiment, the at least monofunctional compound which is reactive toward alkylene oxides is selected from the group of the monofunctional compounds, preferably from the group comprising monols, in particular C₁-C₁₈ monols.

In one preferred embodiment, the at least monofunctional compound which is reactive toward alkylene oxides is selected from the group of the at least difunctional compounds which are reactive toward alkylene oxides.

In one particularly preferred embodiment here, the at least difunctional compound which is reactive toward alkylene oxides is selected from the group comprising polyols, in particular glycerol, ethylene glycol, diethylene glycol, propylene glycol, dipropylene glycol, pentaerythritol, sorbitol, sucrose, C₁-C₁₈ diols, castor oil, epoxidized and ring-opened fatty acids, trimethylolpropane, sugar compounds, e.g. glucose, sorbitol, mannitol, and sucrose, polyfunctional phenols, resols, e.g. oligomeric condensates of phenol and formaldehyde, and Mannich condensates of phenols, of formaldehyde, and of dialkanolamines, and melamine, and also mixtures of at least two of the compounds listed.

Unlike in DMC-catalyzed processes, it is equally possible to use amines or amino alcohols as starter components.

It is preferable to use compounds from the group comprising hexamethylenediamine, ethylenediamine, propylenediamine, orthocyclohexanediamine, aminocyclohexanealkylamine, and aromatic amines selected from the group comprising toluenediamine (TDA), diphenylmethanediamine (MDA), or polymeric MDA (p-MDA). In the case of TDA, it is particularly the 2,3- and 3,4-isomers, also known as vicinal TDA, that are used.

The alkylene oxides for the process of the invention have preferably been selected from the group comprising:

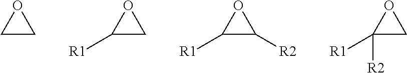

Each of R1 and R2 here has been selected from the group comprising alkyl, aryl, alkenyl.

Alkyl here preferably means a radical selected from the group of the C1-C10-alkyl compounds, preferably C1-C2 compounds, particularly preferably C1 compounds.

Aryl preferably means a phenyl radical.

Alkenyl preferably means a radical selected from the group of the C2-C10-alkenyl compounds, preferably C3-alkenyl compound.

In one preferred embodiment of the invention, the alkylene oxide has been selected from the group comprising ethylene oxide (EO), propylene oxide (PO), and butylene oxide. In one particularly preferred embodiment of the invention, the alkylene oxide is propylene oxide.

The temperature at which the reaction for addition of the alkylene oxides is carried out is preferably from 60 to 150° C., particularly preferably from 80 to 130° C., and very particularly preferably from 90 to 120° C., the pressure being from 0.1 to 9 bar.

Once the addition of the alkylene oxides has been concluded, the postreaction phase usually follows, in which the reaction consumes the alkylene oxide. This is usually followed by work-up of the reaction product, for example via distillation, preferably carried out in vacuo, to remove volatile constituents; there is no need for the complicated further work-up that is usual in the case of KOH catalysts, involving neutralization of the catalyst and filtration of the resultant salt. It is moreover possible, during or after the distillation process, to use inert gas or steam for stripping. The stripping process usually takes place within the temperature range from 60 to 150° C. and within the pressure range from 15 to 1013 mbar. The inert gas or the steam is usually introduced at from 1 to 1900 kg/m³/h. The volume here is based on the reactor volume.

The catalyst of the invention is then optionally quenched, for example via oxidation or hydrolysis.

The invention further provides the polyetherols that can be produced by the process of the invention, and also the use of these for producing polyurethanes.

The invention further provides a process for producing polyetherols, as defined above, where the polyetherol is provided with an EO endcap.

The invention further provides a process for producing a polyurethane via reaction of one or more organic diisocyanates (or polyisocyanates) with a polyether polyol that can be produced by the process of the invention.

The polyurethanes can be produced by the known processes, batchwise or continuously, for example by using reactive extruders or by the belt process, by the “one-shot” process or the prepolymer process (or multistage prepolymer processes as in U.S. Pat. No. 6,790,916B2), preferably by the “one-shot” process. The components that react in these processes: polyesterol, chain extender, isocyanate and optionally auxiliaries and additives (in particular UV stabilizers) can be mixed with one another in succession or simultaneously, whereupon the reaction immediately begins.

The polyurethanes are generally produced via reaction of diisocyanates with compounds having at least two hydrogen atoms reactive toward isocyanate groups, preferably with difunctional alcohols, particularly preferably with the polyetherols that can be produced in the invention.

The diisocyanates used comprise conventional aromatic, aliphatic and/or cycloaliphatic diisocyanates, e.g. diphenylmethane diisocyanate (MDI), tolylene diisocyanate (TDI), tri-, tetra-, penta-, hexa-, hepta-, and/or octamethylene diisocyanate, 2-methylpentamethylene 1,5-diisocyanate, 2-ethylbutylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, dicyclohexylmethane 4,4′-, 2,4′-, and/or 2,2′-diisocyanate.

The compounds used that are reactive toward isocyanates preferably comprise, as described, the polyether alcohols of the invention. Mixed with these, it is possible to use well-known polyhydroxy compounds having molar masses of from 500 to 8000 g/mol, preferably from 600 to 6000 g/mol, in particular 800 to 4000 g/mol, and preferably having average functionality of from 1.8 to 2.6, preferably from 1.9 to 2.2, in particular 2, examples being polyester alcohols, polyether alcohols, and/or polycarbonatediols.

Among the compounds reactive toward isocyanates are also the chain extenders. Chain extenders that can be used comprise well-known, in particular difunctional compounds such as diamines and/or alkanediols having from 2 to 10 carbon atoms in the alkylene radical, in particular ethylene glycol and/or 1,4-butanediol, and/or hexanediol, and/or di- and/or trioxyalkylene glycols having from 3 to 8 carbon atoms in the oxyalkylene radical, preferably corresponding oligo-polyoxypropylene glycols, and it is also possible here to use a mixture of the chain extenders. Other chain extenders that can be used are 1,4-bis(hydroxymethyl)benzene (1,4-BHMB), 1,4-bis(hydroxyethyl)benzene (1,4-BHEB), or 1,4-bis(2-hydroxyethoxy)benzene (1,4-HQEE). The chain extenders used preferably comprise ethylene glycol and hexanediol, particular preference being given to ethylene glycol.

It is usual to use catalysts which accelerate the reaction between the NCO groups of the diisocyanates and the hydroxyl groups of the structural components, examples being tertiary amines, such as triethylamine, dimethylcyclohexylamine, N-methylmorpholine, N,N′-dimethylpiperazine, 2-(dimethylaminoethoxy)ethanol, diazabicyclo[2.2.2]octane, and the like, and also in particular organometallic compounds, such as titanic esters, iron compounds, e.g. iron(III) acetylacetonate, tin compounds, such as tin diacetate, tin dilaurate, or the dialkyltin salts of aliphatic carboxylic acids, e.g. dibutyltin diacetate, dibutyltin dilaurate, or the like. The usual amounts used of the catalysts are from 0.0001 to 0.1 part by weight per 100 parts by weight of polyhydroxy compound.

Other materials that can be added, alongside catalysts, to the structural components are auxiliaries. By way of example, mention may be made of surfactant substances, flame retardants, nucleating agents, lubricants and mold-release agents, dyes and pigments, inhibitors, stabilizers with respect to hydrolysis, light, heat, oxidation, or discoloration, preservatives to counter microbial degradation, inorganic and/or organic fillers, reinforcing agents, and plasticizers.

The technical literature gives more details concerning the abovementioned auxiliaries and additives, for example in “Plastics Additive Handbook”, 5th Edition, H. Zweifel, ed, Hanser Publishers, Munich, 2001, H. Saunders and K. C. Frisch “High Polymers”, volume XVI, Polyurethane [Polyurethanes], parts 1 and 2, Verlag Interscience Publishers 1962 and 1964, Taschenbuch für Kunststoff-Additive [Plastics additives handbook] by R. Gachter and H. Muller (Hanser Verlag Munich 1990) or DE-A 29 01 774.

Apparatuses for producing polyurethanes are known to the person skilled in the art; see by way of example Kunststoffhandbuch, Band VII, Polyurethane [Plastics handbook, volume VII, Polyurethanes], Carl-Hanser-Verlag, Munich, 1st edition 1966, edited by Dr R. Vieweg and Dr. A. Höchtlen, and 2nd edition 1983, and 3rd revised edition of 1993, edited by Dr. G. Oertel.

The present invention therefore provides, as mentioned, the use of a polyether polyol produced by the process of the invention, for producing polyurethanes (hereinafter also termed PU), in particular of flexible PU foam, rigid PU foam, rigid polyisocyanurate (PIR) foam, cellular or non-cellular PU materials, or polyurethane dispersions. The polyurethanes as described above can be used inter alia for producing mattresses, shoe soles, gaskets, hoses, floorcoverings, profiles, paints, adhesives, sealants, skis, automobile seats, running tracks in stadiums, instrument panels, various moldings, potting compositions, foils, fibers, nonwovens, and/or cast floors.

The present invention further provides the use, as catalyst in a process for producing polyetherols, of an N-heterocyclic carbene as defined above.

### EXAMPLES

Some examples are given below for illustration of the invention. The examples serve only for illustration and are not in any way intended to restrict the scope of the claims.

### Ex. 1

25.0 g of diethylene glycol and 0.42 g of 1,3-dimethylimidazolium 2-carboxylate were used as initial charge in a 300 ml reactor. Nitrogen was then used to inertize the vessel. The vessel was heated to 115° C., and 62.37 g of ethylene oxide were metered in. After a reaction lasting 3 h to consume the material, the system was evacuated under full vacuum for 30 minutes and then cooled to 25° C. 78.4 g of product were obtained.

OH number: 328.6 mg KOH/g

Viscosity (25° C.): 62.7 mPas

### Ex. 2

18.42 g of diethylene glycol and 1.37 g of 1,3-dimethylimidazolium 2-carboxylate were used as initial charge in a 300 ml reactor. Nitrogen was then used to inertize the vessel. The vessel was heated to 115° C., and 201.58 g of propylene oxide were metered in, using a pressure limiter set at 7.6 bar. The time required for addition was 8 hours 10 minutes. After a reaction lasting 4 h to consume the material, the system was evacuated under full vacuum for 30 minutes and then cooled to 25° C. 200.14 g of product were obtained.

OH number: 106.5 mg KOH/g

Viscosity (25° C.): 140 mPas

GPC polydispersity: 1.098

### Ex. 3

18.42 g of diethylene glycol and 1.00 g of 1-butyl-3-methylimidazolium 2-carboxylate were used as initial charge in a 300 ml reactor. Nitrogen was then used to inertize the vessel. The vessel was heated to 115° C., and 201.58 g of propylene oxide were metered in, using a pressure limiter set at 7.6 bar. The time required for addition was 10 hours 15 minutes. After a reaction lasting 4 h to consume the material, the system was evacuated under full vacuum for 30 minutes and then cooled to 25° C. 200.14 g of product were obtained.

OH number: 88.1 mg KOH/g

Viscosity (25° C.): 137 mPas

### Ex. 4

18.42 g of diethylene glycol and 0.85 g of 1-ethyl-3-methylimidazolium 2-carboxylate were used as initial charge in a 300 ml reactor. Nitrogen was then used to inertize the vessel. The vessel was heated to 115° C., and 201.58 g of propylene oxide were metered in, using a pressure limiter set at 7.6 bar. The time required for addition was 8 hours 20 minutes. After a reaction lasting 4 h to consume the material, the system was evacuated under full vacuum for 30 minutes and then cooled to 25° C. 200.14 g of product were obtained.

OH number: 89 mg KOH/g

Viscosity (25° C.): 126 mPas

### Ex. 5

18.42 g of diethylene glycol and 1.3 g of di-tert-butylimidazolium 2-carboxylate were used as initial charge in a 300 ml reactor. Nitrogen was then used to inertize the vessel. The vessel was heated to 115° C., and 201.58 g of propylene oxide were metered in, using a pressure limiter set at 7.6 bar. After 6 hours, the pressure exceeded 7.6 bar and did not fall again even when addition was stopped. The reaction was then terminated. The system was evacuated under full vacuum for 30 minutes and then cooled to 25° C. 91.14 g of product were obtained.

OH number: 223 mg KOH/g

Viscosity (25° C.): 51 mPas

### Ex. 6

25.0 g of diethylene glycol and 0.42 g of 1,3-dimethylimidazolium 2-carboxylate were used as initial charge in a 300 ml reactor. Nitrogen was then used to inertize the vessel. The vessel was heated to 115° C., and 62.27 g of ethylene oxide were metered in. After a reaction lasting 2 h to consume the material, the system was evacuated under full vacuum for 30 minutes and then cooled to 25° C. 83.1 g of product were obtained.

OH number: 318 mg KOH/g

Viscosity (25° C.): 62.7 mPas

### Ex. 7

135.00 g of a diethylene-glycol-started, 1,3-dimethylimidazolium 2-carboxylate-catalyzed polypropylene glycol having a hydroxy number of 108 mg KOH/g were charged to a 300 ml reactor. 0.77 g of 1,3-dimethylimidazolium 2-carboxylate was added, and the reactor was heated to 100° C. After vacuum drying, 12.5 g of ethylene oxide were metered in. After a reaction lasting 3 h to consume the material, the system was evacuated under full vacuum for 30 minutes and then cooled to 25° C. 144 g of a clear product were obtained.

OH number: 96 mg KOH/g

Viscosity (25° C.): 128 mPas

### Ex. 8

24.41 g of diethylene glycol, 20.56 g of 1,1,3,3,5,5-hexamethyltricyclosiloxane, and 1.73 g of 1,3-dimethylimidazolium 2-carboxylate were used as initial charge in a 300 ml reactor. The vessel was heated to 110° C., and 185.0 g of propylene oxide were metered in. After a reaction lasting 3 h to consume the material, the system was evacuated under full vacuum for 30 minutes and then cooled to 25° C. 220.3 g of product were obtained.

OH number: 110 mg KOH/g

Viscosity (25° C.): 167 mPas

### Ex. 9

24.40 g of diethylene glycol, 61.68 g of caprolactone, and 1.73 g of 1,3-dimethylimidazolium 2-carboxylate were used as initial charge in a 300 ml reactor. Nitrogen was then used to inertize the vessel. The vessel was heated to 110° C., and 143.91 g of propylene oxide were metered in. After a reaction lasting 3 h to consume the material, the system was evacuated under full vacuum for 30 minutes and then cooled to 25° C. 202.1 g of product were obtained.

OH number: 129 mg KOH/g

Viscosity (25° C.): 281 mPas

The high pressure values indicate consumption of the PO in the reaction.

The process of the invention therefore provides an advantageous alternative to conventional KOH- or DMC-catalyzed processes.

The novel catalysts have high activity, and the amount needed for the catalyst is therefore only small, and EO endcapping of polyetherols of substituted alkylene oxides can be carried out, and it is therefore also possible to construct polyetherol block structures. Copolymerization, e.g. with lactones, is also possible.

When PO is used, side reactions are substantially avoided, and because the viscosity of the reaction mixture is lower than when using KOH catalysis, better heat dissipation can be achieved.

There is moreover no requirement for the time-consuming work-up which is a general feature of KOH-catalyzed processes, at the end of the reaction.

Amines can be used as starters or costarters; and finally the catalyst of the invention can be used in further reactions, e.g. PU production.

The polyetherols that can be produced in the invention can moreover be used advantageously in the production of polyurethanes.

1) A process for producing polyetherols via catalytic ring-opening polymerization of alkylene oxides with at least one at least monofunctional compound which is reactive toward alkylene oxides, where at least one N-heterocyclic carbene is used as catalyst.

2) The process for producing polyetherols, according to claim 1, where the alkylene oxides have been selected from the group comprising ethylene oxide, propylene oxide, and butylene oxide, preferably propylene oxide.

3) The process for producing polyetherols, according to either of the proceeding claims, where the at least monofunctional compound which is reactive toward alkylene oxides has been selected from the group of the at least difunctional compounds reactive toward alkylene oxides.

4) The process for producing polyetherols, according to any of the proceeding claims, where the at least difunctional compounds which are reactive toward alkylene oxides have been selected from the group comprising polyols, in particular glycerol, ethylene glycol, diethylene glycol, propylene glycol, dipropylene glycol, pentaerythritol, sorbitol, sucrose, C₁-C₁₈ diols, castor oil, epoxidized and ring-opened fatty acids, trimethylolpropane, sugar compounds, e.g. glucose, sorbitol, mannitol, and sucrose, polyfunctional phenols, resols, e.g. oligomeric condensates of phenol and formaldehyde, and Mannich condensates of phenols, of formaldehyde, and of dialkanolamines, and melamine, and also mixtures of at least two of the compounds listed.

5) The process for producing polyetherols, according to any of the preceding claims, where the N-heterocyclic carbene has been selected from the group comprising 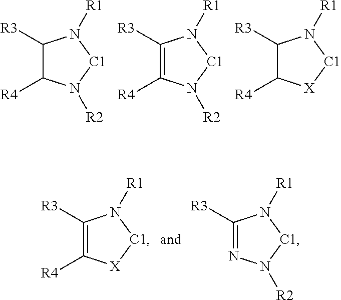
where X has been selected from the group comprising O and S; R1 has been selected from the group comprising alkyl, aryl; R2, if present, has been selected from the group comprising alkyl, aryl; each of R3 and R4 has been selected from the group comprising H, alkyl, aryl; and ring closures between R1 and R3, R3 and R4, and also R4 and R2, are possible.

6) The process for producing polyetherols, according to any of the preceding claims, where the N-heterocyclic carbene is 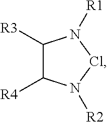
where the definitions of R1, R2, R3, and R4 are as above.

7) The process for producing polyetherols, according to any of the preceding claims, where the N-heterocyclic carbene is 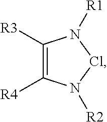
where the definitions of R1, R2, R3, and R4 are as above.

8) The process for producing polyetherols, according to any of the preceding claims where the N-heterocyclic carbene is 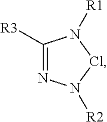
where the definitions of R1, R2, R3, and R4 are as above.

9) The process for producing polyetherols, according to any of claims 6 to 8, where at least one of the two radicals R1 and R2 is a primary alkyl group.

10) The process for producing polyetherols, according to any of claims 6 to 9, where at least one of the two radicals R1 and R2 is a secondary alkyl group.

11) The process for producing polyetherols, according to any of claims 6 to 9, where both radicals R1 and R2 are primary alkyl groups.

12) The process for producing polyetherols, according to any of the preceding claims, where the polyetherol is provided with an EO endcap.

13) The use, as catalyst in a process for producing polyetherols, of at least one N-heterocyclic carbene as defined in any of the preceding claims.

14) A polyetherol that can be produced by the process of any of claims 1 to 12.

15) The use of the polyetherols according to claim 14 for producing polyurethanes.
